(19) United States
(12) Patent Application Publication
(10) Pub. No.: US 2019/0371515 A1
(43) Pub. Date: Dec. 5, 2019

(54) MULTIPLE COILS FOR TRANSMITTING POWER WIRELESSLY

(71) Applicant: HITACHI-LG DATA STORAGE KOREA, INC., Seoul (KR)

(72) Inventors: Hyunwook HA, Seoul (KR); Hogil LEE, Seoul (KR)

(73) Assignee: HITACHI-LG DATA STORAGE KOREA, INC., Seoul (KR)

(21) Appl. No.: 16/424,160

(22) Filed: May 28, 2019

(30) Foreign Application Priority Data
Jun. 5, 2018 (KR) 10-2018-0065106

(51) Int. Cl. H01F 27/28; H01F 38/14; H01F 27/36; H01F 27/02

(52) U.S. Cl. CPC H01F 27/2804; H01F 38/14; H02J 50/10; H01F 27/02; H01F 2027/2809; H01F 27/365

(57) ABSTRACT

The multiple coils for wireless power transmission according to the present invention may comprise a first transmitting coil stacked in a multilayer structure; and a second transmitting coil stacked in the multilayer structure. The outer edge of the first transmitting coil and the outer edge of the second transmitting coil may overlap each other, and the layers of the first transmitting coil and the second transmitting coil may be stacked in turn. Each layer of the first and second transmitting coils forms a wire of a spiral shape and is connected to a previous layer and a next layer through vias formed at an inner terminal and an outer terminal of the wire of the spiral shape.

This application claims the benefit of priority under 35 U.S.C. § 119(a) to Korean Patent Application No. 10-2018-0065106 filed on Jun. 5, 2018, which is incorporated by reference herein in its entirety.

### BACKGROUND

### Field

This disclosure relates to multiple coils for transmitting power wirelessly.

### Related Art

With the development of communication and information processing technology, use of smart terminals such as a smart phone, and the like has gradually increased and at present, a charging scheme generally applied to the smart terminals is a scheme that directly connects an adapter connected to a power supply to the smart terminal to charge the smart phone by receiving external power or connects the adapter to the smart terminal through a USB terminal of a host to charge the smart terminal by receiving USB power.

In recent years, in order to reduce inconvenience that the smart terminal needs to be directly connected to the adapter or the host through a connection line, a wireless charging scheme that wirelessly charges a battery by using magnetic coupling without an electrical contact has been gradually applied to the smart terminal.

In order to solve the problem that a power receiving device moves on the surface of a power transmitting apparatus to deteriorate transmission efficiency and in order to widen a wireless charging region on the surface of the power transmitting apparatus, a multi-coil type transmitting apparatus of an inductive coupling scheme in which a plurality of transmitting coils are arranged to overlap one another has been introduced.

Since, in the wireless power transmitting apparatus of the multi-coil type, the transmitting coil disposed at a center and the transmission coils disposed at the outside are arranged so that a part of the outer areas thereof overlaps with each other, there is a difference in magnetic coupling between the transmitting coils and the receiving coil for respective positions. So, there arises a problem that the transmission efficiency in the transmitting coils disposed close to the receiving coil is high while the transmission efficiency in the transmitting coil disposed relatively far away from the reception coil is low.

FIG. 1 shows the situation in which the position of an electronic device changes on the wireless power transmitting apparatus of the multi-coil type.

The wireless power transmitting apparatus of the multi-coil type may include two or more transmitting coils (or primary coils) located at different positions to transmit power to two or more electronic devices at the same time. As shown in FIG. 1, the wireless power transmitting apparatus of the multi-coil type has three primary coils Tx Coil #1 to TX Coil #3, and TX Coil #2 is disposed at a center and TX Coil #1 and TX Coil #3 are disposed outside TX Coil #2. In FIG. 1, a smart phone moves from the center to the outside while the wireless power transmitting apparatus wirelessly transmits power to the smart phone through TX Coil #2, so the wireless power transmitting apparatus wirelessly transmits power to the smart phone through TX Coil #3. Then, the power transmission efficiency is lowered and charging time becomes longer, because the magnetic coupling between Tx Coil #3 and the receiving coil of the smart phone is lower than the magnetic coupling between Tx Coil #2 and the receiving coil.

### SUMMARY

The present invention has been made in view of such circumstances, and it is an object of the present invention to provide a multi-coil structure which minimizes the difference in the magnetic coupling between a receiving coil and respective transmitting coils in a wireless power transmitting apparatus of a multi-coil type.

Multiple coils for wireless power transmission according to an embodiment of the present invention may comprise a first transmitting coil stacked in a multilayer structure; and a second transmitting coil stacked in the multilayer structure, wherein outer edge of the first transmitting coil and outer edge of the second transmitting coil overlap each other, and layers of the first transmitting coil and the second transmitting coil are stacked in turn.

In an embodiment, each layer of the first and second transmitting coils may be manufactured by a multilayer PCB manufacturing process to form a wire of a spiral shape.

In an embodiment, the each layer of the first and second transmitting coils may be formed through processes including circuit printing, etching and resist stripping in the multilayer PCB manufacturing process.

In an embodiment, the each layer of the first and second transmitting coils may be connected to a previous layer and a next layer through vias formed at an inner terminal and an outer terminal of the wire of the spiral shape

In an embodiment, the inner terminal of the spiral-shaped wire may be connected to the previous layer and the outer terminal of the spiral-shaped wire may be connected to the next layer in an even-numbered layer of the first and second transmitting coils, and the inner terminal of the spiral-shaped wire may be connected to the next layer and the outer terminal of the spiral-shaped wire may be connected to the previous layer in an odd-numbered layer of the first and second transmitting coils. Or the outer terminal of the spiral-shaped wire may be connected to the previous layer and the inner terminal of the spiral-shaped wire may be connected to the next layer in an even-numbered layer of the first and second transmitting coils, and the outer terminal of the spiral-shaped wire may be connected to the next layer and the inner terminal of the spiral-shaped wire may be connected to the previous layer in an odd-numbered layer of the first and second transmitting coils.

In an embodiment, each layer of the first and second transmitting coils may be manufactured by a multilayer PCB manufacturing process to form a wire of a single closed curve a part of which is cut off to have two terminals, a first terminal of the two terminals may be connected to a previous layer through a first via and the a second terminal of the two terminals may be connected to a next layer through a second via.

In an embodiment, positions of the two terminals in respective layers may move by a distance between the two terminals in a same direction along the single closed curve as layers advance. Or, the positions of the two terminals may be same in the respective layers, and directions in which the cut-offed part in the single closed curve is connected to the two terminals may be alternatively changed depending on whether a corresponding layer is an odd-numbered layer or an even-numbered layer.

A wireless power transmitting apparatus according to another embodiment of the present invention may comprise multiple transmitting coils for changing a magnetic field by an alternating current, including a first coil stacked in a multilayer structure and a second coil stacked in the multilayer structure, outer edge of the first transmitting coil and outer edge of the second transmitting coil overlapping each other; a shielding part for limiting propagation of the magnetic field generated in the multiple transmitting coils; and a case for surrounding the multiple transmitting coils and the shielding part, wherein layers of the first coil and the second coil are stacked in turn.

Therefore, charging efficiency may be made uniform regardless of the position of a receiving device in the charging area of a wireless charger. And, even if the receiving device moves during charging, the deterioration of the charging efficiency may be minimized and the charging time may be reduced.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows the situation in which the position of an electronic device changes on the wireless power transmitting apparatus of the multi-coil type,

FIG. 2 conceptually illustrates that power is wirelessly transmitted from a power transmitting apparatus to an electronic device,

FIG. 3 conceptually illustrates a circuit configuration of a power conversion unit of a transmitting apparatus for wirelessly transmitting power in an electromagnetic induction scheme,

FIG. 4 illustrates a configuration for a wireless power transmitting apparatus and a wireless power receiving device to send and receive power and messages,

FIG. 5 is a block diagram of a loop for controlling power transmission between a wireless power transmitting apparatus and a wireless power receiving device,

FIG. 6 shows a coil arrangement structure of a conventional multi-coil type wireless power transmitting apparatus using three transmitting coils,

FIG. 7 shows a cross-sectional view of conventional multiple coils using a multi-layer structure,

FIG. 8 compares a cross-sectional view of the multiple coils obtained by stacking in turn according to an embodiment of the present invention with a cross-sectional view of the multiple coils obtained by sequentially stacking,

FIG. 9 is a graph showing a change in coupling coefficient between each of the transmitting coil and a receiving coil when the receiving coil moves,

FIG. 10 shows a maximum coupling coefficient between the transmitting coils and the receiving coil,

FIGS. 11 and 12 illustrate the positions of two ends for connecting each layer to previous and next layers through vias when a multi-layer transmitting coil is manufactured by a PCB manufacturing process,

FIG. 13 shows an exploded perspective view of a charger equipped with multiple coils which are stacked in a multi-layered structure and cross-stacked with neighboring transmitting coils according to the present invention.

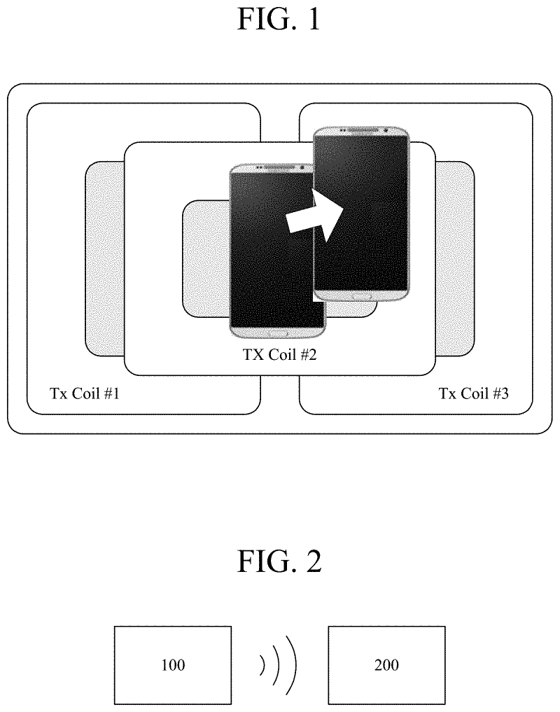

### DETAILED DESCRIPTION

Hereinafter, an embodiment of multiple coils for wirelessly transmitting or receiving power according to the present invention will be described in detail with reference to the accompanying drawings.

FIG. 2 conceptually illustrates that power is wirelessly transmitted from a power transmitting apparatus to an electronic device.

The wireless power transmitting apparatus 100 may be a power transferring apparatus wirelessly transferring power required by a wireless power receiving apparatus or an electronic device 200, or a wireless charging apparatus for charging a battery by wirelessly transferring power. Or the wireless power transmitting apparatus 100 may be implemented by one of various types of apparatuses transferring power to the electronic device 200 requiring power with non-contact.

The electronic device 200 may be operable by wirelessly receiving power from the wireless power transmitting apparatus 100 and charge a battery by using wirelessly received power. The electronic device that wirelessly receives power may include portable electronic devices, for example, a smart phone, a tablet computer, a multimedia terminal, an input/output device such as a keyboard, a mouse, a video or audio auxiliary device, a secondary battery, and the like.

Power may be wirelessly transmitted by an inductive coupling scheme based on an electromagnetic induction phenomenon by a wireless power signal generated by the wireless power transmitting apparatus 100. That is, resonance is generated in the electronic device 200 by the wireless power signal transmitted by the wireless power transmitting apparatus 100 and power is transferred from the wireless power transmitting apparatus 100 to the electronic device 200 without contact by the resonance. A magnetic field is changed by an AC current in a primary coil and current is induced to a secondary coil by the electromagnetic induction phenomenon to transfer power.

When the intensity of the current that flows on a primary coil of the wireless power transmitting apparatus 100 is changed, the magnetic field passing through the primary coil (or a transmitting Tx coil) is changed by the current and the changed magnetic field generates induced electromotive force at a secondary coil (or a receiving Rx coil) in the electronic device 200.

When the wireless power transmitting apparatus 100 and the electronic device 200 are disposed such that the transmitting coil at the wireless power transmitting apparatus 100 and the receiving coil at the electronic device 200 come close to each other and the wireless power transmitting apparatus 100 controls the current of the transmitting coil to be changed, the electronic device 200 may supply power to a load such as a battery by using the electromotive force induced to the receiving coil.

Efficiency of the wireless power transmission based on the inductive coupling scheme is influenced by a layout and a distance between the wireless power transmitting apparatus 100 and the electronic device 200. The wireless power transmitting apparatus 100 is configured to include a flat interface surface and a transmitting coil is mounted on the bottom of the interface surface and one or more electronic devices may be laid on the top of the interface surface. By making the gap between the transmitting coil mounted on the bottom of the interface surface and the receiving coil positioned on the top of the interface surface sufficiently small, the efficiency of the wireless power transmission by the inductive coupling method can be increased.

A mark indicating a location where the electronic device is to be laid may be displayed on the top of the interface surface. The mark may indicate indicate the position of the electronic device which makes the arrangement between the primary coil mounted on the bottom of the interface surface and the secondary coil suitable. A protruded structure for guiding the location of the electronic device may be formed on the top of the interface surface. And a magnetic body may be formed on the bottom of the interface surface so that the primary coil and the secondary coil can be guided by an attractive force with a magnetic body of the other pole provided inside the electronic device.

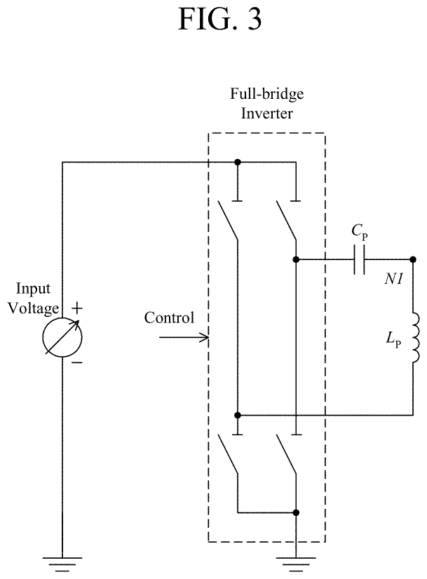

FIG. 3 conceptually illustrates a circuit configuration of a power conversion unit of a transmitting apparatus for wirelessly transmitting power in an electromagnetic induction scheme.

The wireless power transmitting apparatus may include a power conversion unit generally including a power source, an inverter, and a resonance circuit. The power source may be a voltage source or a current source and the power conversion unit converts the power supplied from the power source into a wireless power signal and transfers the converted wireless power signal to a receiving device. The wireless power signal is formed in the form of the magnetic field or an electronic magnetic field having a resonance characteristic. And, the resonance circuit includes a coil generating the wireless power signal.

The inverter converts a DC input into an AC waveform having a desired voltage and a desired frequency through switching elements and a control circuit. And, in FIG. 2 a full-bridge inverter is illustrated and other types of inverters including a half-bridge inverter, and the like are also available.

The resonance circuit includes a primary coil Lp and a capacitor Cp to transmit power based on a magnetic induction scheme. The coil and the capacitor determine a basic resonance frequency of power transmission. The primary coil forms the magnetic field corresponding to the wireless power signal with a change of current and may be implemented in a flat form or a solenoid form.

The AC current converted by the inverter drives the resonance circuit, and as a result, the magnetic field is formed in the primary coil. By controlling the on/off timings of included switches, the inverter generates AC having a frequency close to the resonance frequency of the resonance circuit to increase transmission efficiency of the transmitting apparatus. The transmission efficiency of the transmitting apparatus may be changed by controlling the inverter.

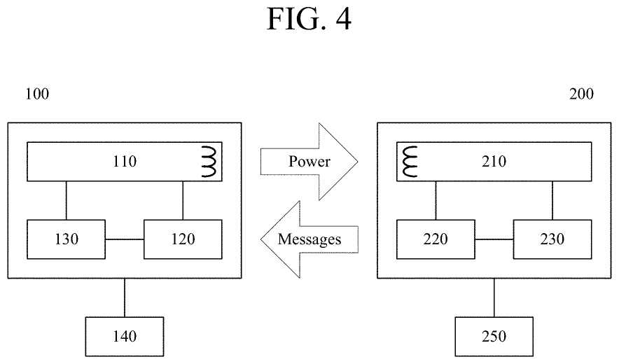

FIG. 4 illustrates a configuration for a wireless power transmitting apparatus and a wireless power receiving device to send and receive power and messages.

Since the power conversion unit just transmits power unilaterally regardless of a receiving state of the receiving device, a configuration for receiving feedback associated with the receiving state from the receiving device is required in the wireless power transmission apparatus in order to transmit power in accordiance with the state of the receiving device.

The wireless power transmitting apparatus 100 may include a power conversion unit 110, a first communication unit 120, a first control unit 130, and a power supply unit 140. And, the wireless power receiving device 200 may include a power receiving unit 210, a second communication unit 220, and a second control unit 230 and may further include a load 250 to which received power is to be supplied.

The power conversion unit 110 includes the inverter and the resonance circuit of FIG. 3 and may further include a circuit to control characteristics including a frequency, voltage, current, and the like used to form the wireless power signal.

The first communication unit 120, connected to the power conversion unit 110, may demodulate the wireless power signal modulated by the receiving device 200 wirelessly receiving power from the transmitting apparatus 100 in the magnetic induction scheme, thereby detecting a power control message.

The first control unit 130 determines one or more characteristics among an operating frequency, voltage, and current of the power conversion unit 110 based on the message detected by the communication unit 120 and controls the power conversion unit 110 to generate the wireless power signal suitable for the message. The first communication unit 120 and the first control unit 130 may be configured as one module.

The power receiving unit 210 may include a matching circuit, including the secondary coil and a capacitor, which generates the inductive electromotive force according to the change of the magnetic field generated from the primary coil of the power conversion unit 110, and may further include a rectification circuit that rectifies the AC current that flows on the secondary coil to output DC current.

The second communication unit 220, connected to the power receiving unit 210, may change the wireless power signal between the transmitting apparatus and the receiving device by adjusting the load of the power receiving unit in accordance with a method of adjusting a resistive load at DC and/or a capacitive load at AC to transmit the power control message to the transmitting apparatus.

The second control unit 230 controls individual components included in the receiving device. The second control unit 230 may measure an output of the power receiving unit 210 in a current or voltage form and control the second communication unit 220 based on the measured output to transfer the power control message to the wireless power transmitting apparatus 100. The message may direct the wireless power transmitting apparatus 100 to start or terminate the transmission of the wireless power signal and to control characteristics of the wireless power signal.

The wireless power signal formed by the power conversion unit 110 is received by the power receiving unit 210, and the second control unit 230 of the receiving device controls the second communication unit 220 to modulate the wireless power signal. The second control unit 230 may perform a modulation process to change the amount of power received from the wireless power signal by changing the reactance of the second communication unit 220. When the amount of power received from the wireless power signal is changed, a current and/or voltage of the power conversion unit 110 forming the wireless power signal is also changed and the first communication unit 120 of the wireless power transmitting apparatus 100 may sense the change in the current and/or voltage of the power conversion unit 110 and perform a demodulation process.

The second control unit 230 generates a packet including a message to be transferred to the wireless power transmitting apparatus 100 and modulates the wireless power signal to include the generated packet. The first control unit 130 may acquire the power control message by decoding the packet extracted through the first communication unit 120. The second control unit 230 may transmit a message for requesting a change of the characteristic of the wireless power signal based on the amount of power received through the power receiving unit 210 in order to control to-be-received power.

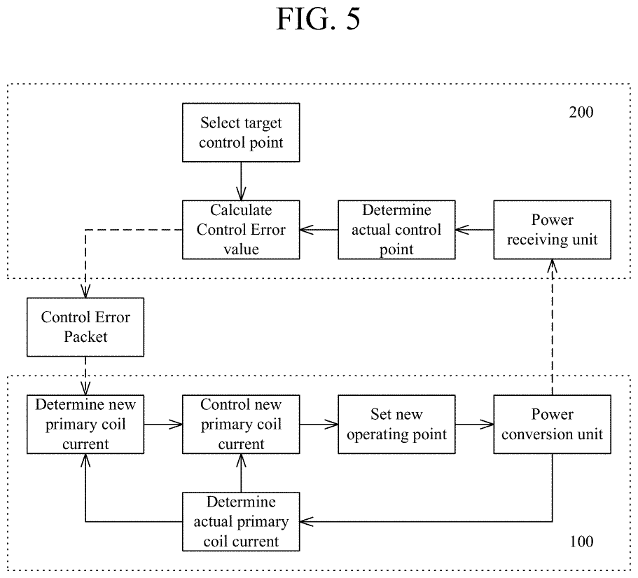

FIG. 5 is a block diagram of a loop for controlling power transmission between a wireless power transmitting apparatus and a wireless power receiving device.

Current is induced in the power receiving unit 210 of the receiving device 200 according to the change of the magnetic field generated by the power conversion unit 110 of the transmitting apparatus 100 and power is transmitted. The second control unit 230 of the receiving device selects a desired control point, that is, a desired output current and/or voltage and determines an actual control point of the power received through the power receiving unit 210.

The second control unit 230 calculates a control error value by using the desired control point and the actual control point while the power is transmitted and may take the difference between, for example, two output voltages or two output currents as the control error value. When less power is required to reach the desired control point, the control error value may be determined to be, for example, a minus value, and when more power is required to reach the desired control point, the control error value may be determined to be a plus value. The second control unit 230 may generate a packet including the calculated control error value calculated by changing the reactance of the power receiving unit 210 with time through the second communication unit 220 to transmit the packet to the transmitting apparatus 100.

The first communication unit 120 of the transmitting apparatus detects a message by demodulating the packet included in the wireless power signal modulated by the receiving device 200 and may demodulate a control error packet including the control error value.

The first control unit 130 of the transmitting apparatus may acquire the control error value by decoding the control error packet extracted through the first communication unit 120 and determine a new current value for transmitting power desired by the receiving device by using an actual current value which actually flows on the power conversion unit 110 and the control error value.

When the process of receiving the control error packet from the receiving device is stabilized, the first control unit 130 controls the power conversion unit 110 so that an operating point reaches a new operating point so an actual current value which flows on the primary coil becomes a new current value and a magnitude, a frequency, a duty ratio, or the like of an AC voltage applied to the primary coil becomes a new value. And, the first control unit 130 controls the new operating point to be continuously maintained so as for the receiving device to additionally communicate control information or state information.

Interactions between the wireless power transmitting apparatus 100 and the wireless power receiving device 200 may comprise four steps of selection, ping, identification and configuration, and power transfer. The selection step is a step for a transmitting apparatus to discover an object laid on the surface of an interface. The ping step is a step for verifying whether the object includes a receiving device. The identification and configuration step is a preparation step for sending power to the receiving device during which appropriate information is received from the receiving device and a power transfer contract with the receiving device is made based on the received information. The power transfer step is a step of actually transmitting power to the receiving device wirelessly through the interaction between the transmitting apparatus and the receiving device.

In the ping step, the receiving device 200 transmits a signal strength packet SSP indicating a magnetic flux coupling degree between a primary coil and a secondary coil through the modulation of a resonance waveform. The signal strength packet SSP is a message generated by the receiving device based on a rectified voltage. The transmitting apparatus 100 may receive the message from the receiving device 200 and use the message to select an initial driving frequency for power transmission.

In the identification and configuration step, the receiving device 200 transmits to the transmitting apparatus 100 an identification packet including a version, a manufacturer code, apparatus identification information, and the like of the receiving device 200, a configuration packet including information including maximum power, a power transmitting method, and the like of the receiving device 200, and the like.

In the power transmitting step, the receiving device 200 transmits to the transmitting apparatus 100 a control error packet CEP indicating a difference between an operating point where the receiving device 200 receives a power signal and the operating point determined in the power transfer contract, a received power packet RPP indicating an average of the power which the receiving device 200 receives through the surface of the interface, and the like.

The received power packet RPP is the data about the amount of received power, which is obtained by taking a rectified voltage, a load current, an offset power, etc. of the power receiving unit 210 of the receiving device, and continuously transmitted to the transmitting apparatus 100 while the receiving device 200 receives power. The transmitting apparatus 100 receives the reception power packet RPP and uses it as an operation factor for power control.

The first communication unit 120 of the transmitting apparatus extracts the packets from change in resonance waveform, and the first control unit 130 decodes the extracted packets to acquire the messages and controls the power conversion unit 110 based thereon to wirelessly transmit power while changing power transmission characteristics as the receiving device 200 requests.

Meanwhile, in a scheme that wirelessly transfers power based on inductive coupling, the efficiency is less influenced by frequency characteristics, but influenced by the arrangement and distance between the transmitting apparatus 100 and the receiving device 200.

An area which the wireless power signal can reach may be divided into two. A portion of the interface surface through which a high efficiency magnetic field can pass when the transmitting apparatus 100 wirelessly transmits power to the receiving device 200 may be referred to as an active area. An area where the transmitting apparatus 100 can sense the existence of the receiving device 200 may be referred to as a sensing area.

The first control unit 130 of the transmitting apparatus may sense whether the receiving device is disposed in or removed from the active area or the sensing area. The first control unit 130 may detect whether the receiving device 200 is disposed in the active area or the sensing area by using the wireless power signal formed in the power conversion unit 110 or using a separately provided sensor.

For example, the first control unit 130 may detects whether the receiving device exists by monitoring whether the power characteristics for forming the wireless power signal is changed while the wireless power signal is being affected by the receiving device 200 existing in the sensing area. The first control unit 130 may perform a process of identifying the receiving device 200 or determine whether to start wireless power transfer, according to a result of detecting the existence of the receiving device 200.

The power conversion unit 110 of the transmitting apparatus may further include a position determination unit. The position determination unit may move or rotate the primary coil in order to increase the efficiency of the wireless power transfer based on the inductive coupling scheme and in particular, be used when the receiving device 200 does not exist in the active area of the transmitting apparatus 100.

The position determination unit may include a driving unit for moving the primary coil so that a distance between the centers of the primary coil of the transmitting apparatus 100 and the secondary coil of the receiving device 200 is within a predetermined range or so that the centers of the primary coil and the secondary coil overlap with each other. To this end, the transmitting apparatus 100 may further include a sensor or a sensing unit for sensing the position of the receiving device 200. And the first control unit 130 of the transmitting apparatus may control the position determination unit based on the positional information of the receiving device 200, which is received from the sensor of the sensing unit.

Alternatively, the first control unit 130 of the transmitting apparatus may receive control information regarding the arrangement with or distance from the receiving device 200 through the first communication unit 120 and control the position determination unit based on the control information.

Further, the transmitting apparatus 100 may include two or more primary coils to increase transmission efficiency by selectively using some primary coils arranged appropriately with the secondary coil of the receiving device 200 among the two or more primary coils. In this case, the position determination unit may determine which primary coils of the two or more primary coils are used for power transmission.

single primary coil or a combination of one or more primary coils forming the magnetic field passing through the active area may be designated as a primary cell. The first control unit 130 of the transmitting apparatus may sense the position of the receiving device 200, determine the active area based on the determined active area, connect a transmitting module configuring the primary cell corresponding to the active area and control the primary coils of the transmitting module to be inductively coupled to the secondary coil of the receiving device 200.

Meanwhile, since the receiving device 200 is embedded in a smart phone or an electronic apparatus such as a multimedia reproduction terminal or a smart apparatus and is laid in a direction or a location which is not constant in a vertical or horizontal direction on the surface of the interface of the transmitting apparatus 100, the transmitting apparatus requires a wide active area.

When a plurality of primary coils are used in order to widen the active area, driving circuits are required as many as the primary coils and controlling the plurality of primary coils is complicated. As a result, the cost of the transmitting apparatus or a wireless charger increases during commercialization. Further, in order to extend the active area, even when a scheme of changing the location of the primary coil is applied, since it is necessary to provide a transport mechanism for moving the location of the primary coil, there is a problem that a volume and a weight increase and manufacturing cost increases.

A method that extends the active area even with one primary coil of which the location is fixed is effective. However, when the size of the primary coil is just increased, a magnetic flux density per area decreases and magnetic coupling force between the prmary coil and the secondary coil is weakened. As a result, the active area is not so increased as expected and the transmission efficiency is also lowered.

As such, it is important to determine an appropriate shape and an appropriate size of the primary coil in order to extend the active area and improve the transmission efficiency. A multi-coil scheme adopting two or more primary coils may be an effective method that extends the active area of the wireless power transmitting apparatus.

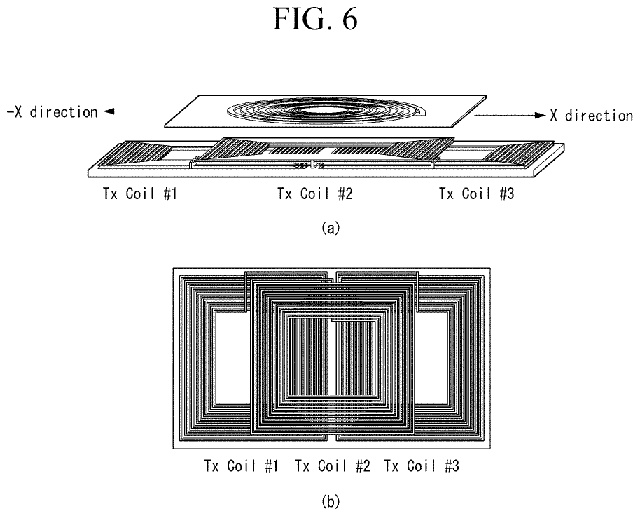

FIG. 6 shows a coil arrangement structure of a conventional multi-coil type wireless power transmitting apparatus using three transmitting coils.

A plurality of transmitting coils are arranged in order to widen a wireless charging area in a wireless power transmitting apparatus. In order to ensure that there is no dead zone where the receiving device placed on the wireless charging area cannot receive power, in a conventional structure, for example three transmitting coils (first to third transmitting coils Tx Coil #1, Tx Coil #2, and Tx Coil #3) are arranged in the x direction as shown in FIG. 6, and the first to third transmitting coils are disposed such that the left outer edge and the right outer edge of the second transmitting coil Tx Coil #2 located at a center are respectively overlapped with the outer edges of the first transmitting coil Tx Coil #1 and the third transmitting coil Tx Coil #3.

Since the receiving coil of a power receiving device is placed above a wireless power transmitting apparatus in FIG. 6, the first transmitting coil Tx Coil #1 and the third transmitting coil Tx Coil #3 disposed at the outer side are arranged below and the second transmitting coil Tx Coil #2 disposed at the center is disposed thereon, so the second transmitting coil Tx Coil #2 becomes closest to the receiving coil.

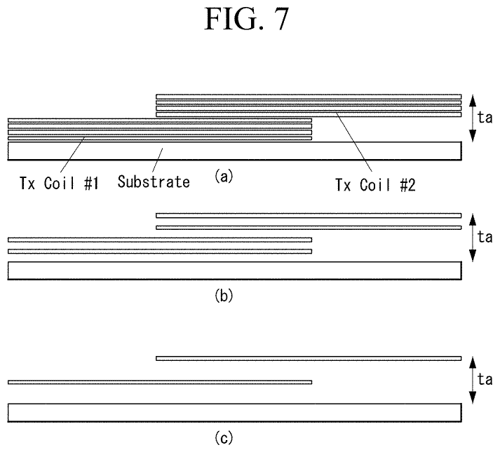

FIG. 7 shows a cross-sectional view of conventional multiple coils using a multi-layer structure. FIG. 7 enlarges only a portion where two coils overlap. In FIG. 7, (a) is a structure in which each coil is stacked with four layers, and (b) is a structure in which each coil is stacked with two layers, and (c) is a structure in which each coil comprises only one layer.

There is an attempt to reduce AC resistance component by manufacturing coils with a multi-layered structure as shown in FIG. 7 taking the skin effect generated in a coil wire into consideration when transmitting power at a high frequency of several hundreds of kHz. In FIG. 7, the gap to between the coil layer at the highest position and the lower substrate (for example a ferrite sheet, a shielding sheet, or a substrate formed by laminating them) is all the same.

For example in case of operating at 100 kHz, since the skin effect depth due to the skin effect is 200 μm and a current does not flow above the depth in a wire, implementing a copper foil with a thickness of 400 μm in a multilayer structure may be advantageous in reducing the AC resistance.

When arranging transmitting coils in a structure where outer edges of the transmitting coils overlap each other in order to widen the charging area, the first transmitting coil Tx Coil #1 located at the outer side of the power transmitting apparatus is first stacked in a multilayer structure, and then the second transmitting coil Tx Coil #2 is stacked in a multilayer manner on the first transmitting coil Tx Coil #1, as shown in FIG. 7. That is, a conventional power transmitting apparatus adopts, as a method of stacking multiple coils, a sequentially stacking structure in which one transmitting coil is stacked on another transmitting coil which are already stacked in a region where two adjacent transmitting coils are overlapped.

So, there occurs the difference between the magnetic coupling degree kr1 or kr3 between a receiving coil and the first or third transmitting coil Tx Coil #1 or Tx Coil #3 located relatively below and the magnetic coupling degree kr2 between the receiving coil and the second transmitting coil Tx Coil #2 located relatively above, and the relationships kr2>kr1=kr3 holds.

Since the magnetic coupling degree between the transmitting coil and the receiving coil is an important factor determining transmitting efficiency, the transmitting efficiency is high in the vicinity of the second transmitting coil Tx Coil #2 while the transmitting efficiency is relatively low in the vicinity of the first or third transmitting coil Tx Coil #1 or Tx Coil #3 in the wireless power transmitting apparatus of the sequential stacking structure.

When stacking each transmitting coil in a multi-layer structure in the power transmitting apparatus of the multi-coil type in order to reduce the AC resistance, the present invention stacks two or more transmitting coils which are adjacent to one another and overlap one another in their outer edges in turn or in a cross-stacking manner, thereby reducing the difference in the magnetic coupling degree between each transmitting coil and the receiving coil.

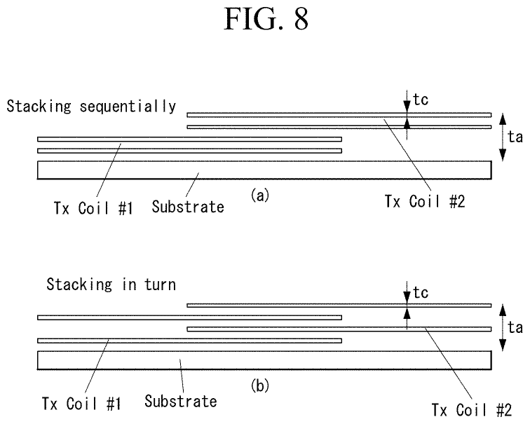

FIG. 8 compares a cross-sectional view of the multiple coils obtained by stacking in turn according to an embodiment of the present invention with a cross-sectional view of the multiple coils obtained by sequentially stacking. FIG. 8a is a structure in which layers of each of two adjacent multi-layer transmitting coils are sequentially stacked, and FIG. 8b is a structure in which layers of each of two adjacent multi-layer transmitting coils are stacked in turn according to a present invention.

If sequentially stacking the transmitting coils, the transmitting coil stacked below is farther than the transmitting coil stacked above from a receiving coil, so the transmitting coil stacked below is inevitably low in the magnetic coupling degree with the receiving coil. In order to solve such a problem, layers of two adjacent multi-layered transmitting coils are stacked in turn, thereby reducing the deviation of the distances between the receiving coil and respective transmitting coils and reducing and reducing the difference of the magnetic coupling degrees.

As shown in FIG. 8b, a first transmitting coil Tx Coil #1 and a second transmitting coil Tx Coil #2 are stacked in turn such that a first layer of a first transmitting coil Tx Coil #1 is formed on a substrate, a first layer of a second transmitting coil Tx Coil #2 is formed on the first layer of the first transmitting coil Tx Coil #1, a second layer of the first transmitting coil Tx Coil #1 is formed on the first layer of the second transmitting coil Tx Coil #2, and the second layer of the second transmitting coil Tx Coil #2 is formed on the second layer of the first transmitting coil Tx Coil #1.

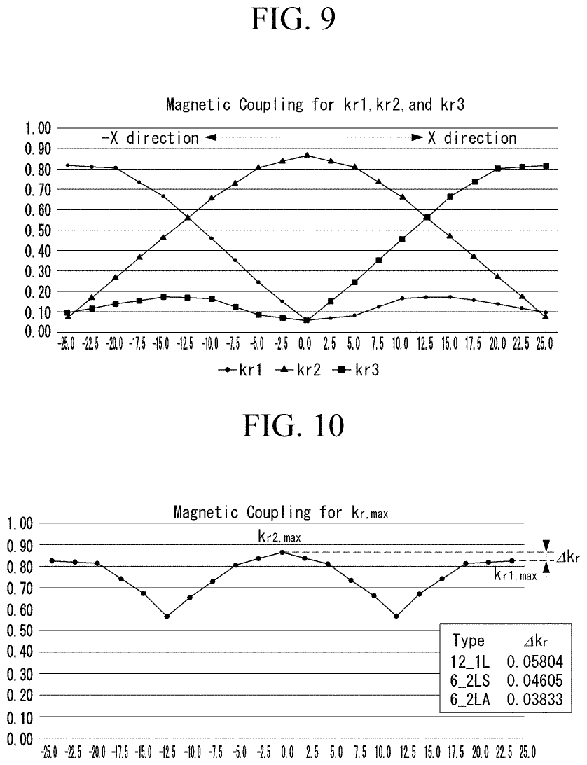

FIG. 9 is a graph showing a change in coupling coefficient between each of the transmitting coil and a receiving coil when the receiving coil moves, and FIG. 10 shows a maximum coupling coefficient between the transmitting coils and the receiving coil.

If measuring magnetic coupling degrees between a receiving coil and respective transmitting coils while moving the receiving coil in a x-direction, in a state that the respective coils constituting multiple transmitting coils are stacked in a multi-layered structure and layers of two adjacent transmitting coils are stacked in turn as shown in FIG. 8b, the magnetic coupling degrees are obtained as FIG. 9. In FIG. 9, kr1 is magnetic coupling degree between a first transmitting coil Tx Coil #1 and the receiving coil, kr2 is magnetic coupling degree between a second transmitting coil Tx Coil #2 and the receiving coil, and kr3 is magnetic coupling degree between a third transmitting coil Tx Coil #3 and the receiving coil.

The receiving coil of a power receiving device is coupled with one transmitting coil with which the magnetic coupling degree is the highest among three transmitting coils for wirelessly receiving power. So, if measuring the magnetic coupling degree while moving the power receiving device in x-direction, it may be identified that the magnetic coupling degree varies as shown in FIG. 10. When defining a change rate of the magnetic coupling degree is defined as Δkr=kr2,max−kr1,max, the change rate of the magnetic coupling degree is displayed on FIG. 10.

When a structure in which a thickness of a coil is 12 OZ and each transmitting coil has a single layer is 12_1L, a structure in which the thickness of the coil is 6 OZ and each transmitting coil has dual layers which are sequentially stacked is 6_2LS, and a structure in which the thickness of the coil is 6 OZ and each transmitting coil has dual layers which are stacked in turn with the layers of another transmitting coil is 6_2LA, the change rates of the magnetic coupling degrees for 3 structures are respectively 0.058, 0.046 and 0.038, which shows that the structure of stacking the layers in turn has the most excellent. Here, 1 Oz indicates 35 um.

Meanwhile, in case that a transmitting coil of a multi-layer structure is formed by winding Litz wires, a first layer of a first transmitting coil Tx Coil #1 is formed by winding a wire of the first transmitting coil Tx Coil #1 one turn, a first layer of a second transmitting coil Tx Coil #2 is formed by winding a wire of the second transmitting coil Tx Coil #2 one turn on the first layer of the first transmitting coil Tx Coil #1, a second layer of the first transmitting coil Tx Coil #1 is formed by winding the wire of the first transmitting coil Tx Coil #1 one turn on the first layer of the second transmitting coil Tx Coil #2, and a second layer of the second transmitting coil Tx Coil #2 is formed by winding the wire of the second transmitting coil Tx Coil #2 one turn on the second layer of the first transmitting coil Tx Coil #1.

Multiple coils that are sequentially stacked in a multi-layer structure may be fabricated by a multilayer PCB manufacturing process. In this case, for each layer of the multiple coils sequentially stacked, the processes which include circuit printing, etching, resist stripping, insulating layer laminating, and via hole trimming are performed to form a copper foil of a corresponding layer, and then respective layers are laminated using adhesive.

When forming each transmitting coil in a multi-layer structure through multi-layer PCB processing, respective layers may be formed with a same shape and size, for example circle, square, or equilateral triangle of a same size. A wire or a copper foil that makes up each layer must be connected to wires of the other layers, that is a previous layer and a next layer in series.

In case of forming the wire of each layer of respective transmitting coils in a spiral shape, the wire of a corresponding layer is connected to that of a previous layer (or a lower layer) and that of a next layer (or a upper layer) through an inner terminal and an outer terminal. Since current must flow in a same direction in the wires of respective layers in a transmitting coil having multi layers, a wire of the spiral shape in each even layer is connected to a wire of a previous layer through an inner terminal and connected to a wire of a next layer through an outer terminal, and a wire of the spiral shape in each odd layer is connected to a wire of a previous layer through an outer terminal and connected to a wire of a next layer through an inner terminal. The opposite is also possible. Vias may be formed at both ends of the wire of each layer to connect the wire to the wires of a previous layer and a next layer.

Meanwhile, in case of forming each layer of a transmitting coil in a single closed curve rather than a spiral shape, in order to connect a wire of each layer to both the wires of a previous layer and a next layer in series, a part of the closed curve corresponding to the shape of the transmitting coil may be cut off to form two ends, and one of the two ends may be connected to the previous layer and the other of the two ends may be connected to the next layer through vias.

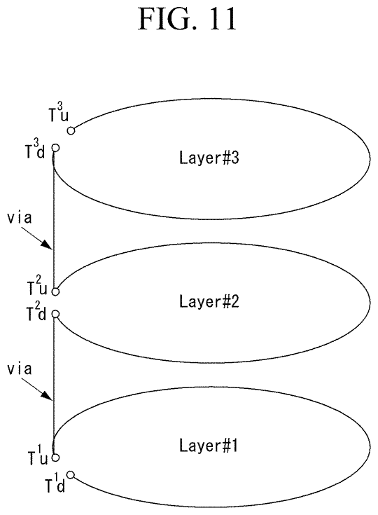

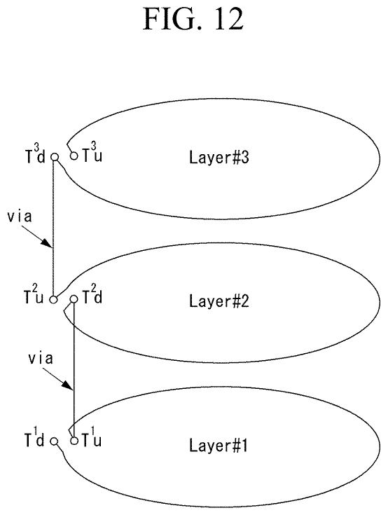

Current must flow in a same direction in respective layers of a transmitting coil having multi layers, and each layer in which a wire of a same shape is formed must be connected to a lower layer and an upper layer in series. So, as shown in FIG. 11, the positions of two ends or terminals Td and Tu at which vias are formed in each layer may move by the distance between the two ends in a same direction along the closed curve as the layers advances. Or, as shown in FIG. 12, the positions of two ends Td and Tu at which vias are formed in each layer may be fixed and the directions in which the cut-offed part in the closed curve is connected to the two vias may be alternatively changed depending on whether it is an odd-numbered layer or an even-numbered layer.

In FIG. 11, the positions at which the two terminals are formed move in a clockwise direction by a distance between the two terminals as layers advance from a first layer Layer #1 through a second layer Layer #2 to a third layer Layer #3. And, a upward terminal T1u of a previous layer Layer #1 is same as a downward terminal T2d of a current layer Layer #2 in their positions, and a upward terminal T2u of the current layer Layer #2 is same as a downward terminal T3d of a next layer Layer #3 in their positions.

In FIG. 12, the positions of two terminals are same in respective layers. The positions of upward terminals Tu and downward terminals Td are switched from odd-numbered layers to even-numbered layers. In the first and third layers Layer #1 and Layer #3, that is in odd-numbered layers, the downward terminals Td are located outside of the closed curve of a circular shape and the upward terminals Tu are located inside of the closed curve. And, in the second layer Layer #2, that is in an even-numbered layer, the downward terminal Td is located inside of the closed curve of the circular shape and the upward terminal Tu is located outside of the closed curve.

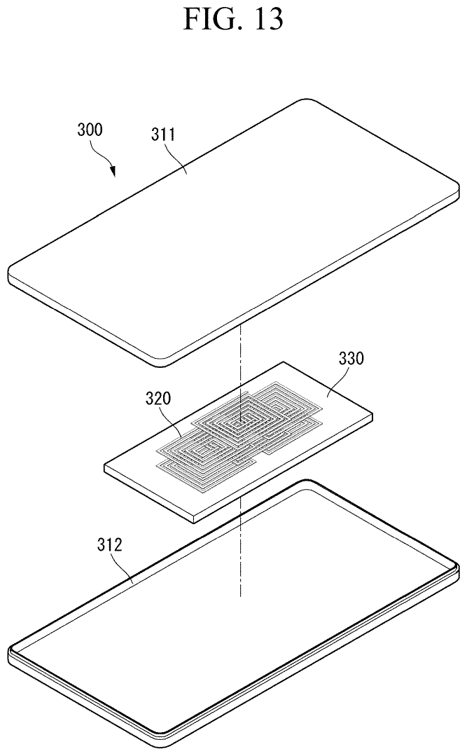

FIG. 13 shows an exploded perspective view of a charger equipped with multiple coils which are stacked in a multi-layered structure and cross-stacked with neighboring transmitting coils according to the present invention.

The charger 300 in FIG. 13 may include a wireless power transmitting apparatus that provides inductive power. On the upper surface of the charger, an electronic device including the power receiving device to be charged is placed, and a seating surface having an operation area may be formed. When the electronic device is placed on the seating surface, the charger may detect this and start wireless charging.

In the charger 300, the multiple transmitting coils 320 cross-stacked in a multi-layered structure as in FIG. 8 may be mounted between a front case 311 and a rear case 312, and a shielding part 330 may be formed under the multiple transmitting coils 320. That is, the shielding part 330 may be formed between the rear case 312 and the multiple transmitting coils 320 of the charger 300 and may be formed so as to at least partially exceed the outer periphery of the multiple transmitting coils 320.

The shielding part 330 may prevent elements such as a microprocessor, a memory, and the like formed on a circuit board (not shown) from being affected by electromagnetic effects due to the operation of the multiple transmitting coils 320, or prevent the multiple transmitting coils 320 from being affected by the electromagnetic effects due to the operations of the elements mounted on the circuit board. The shielding part 330 may be made of stainless steel or titanium which does not require plating.

Furthermore, a ferrite sheet (not shown) is provided between the multiple transmitting coils 320 and a circuit board (not shown), which makes it possible to prevent electromagnetic interference such as an eddy current generated in the multiple transmitting coils 320 or the circuit board from affecting other components.

The charger 300 may have a structure in which a power conversion unit including a transmitting coil, a communication unit, a control unit, a power supply unit, and the like are provided in one body. Or, the charger 300 may a structure in which a first body to which the multiple transmitting coils 320 and the shielding part 330 are mounted is separated from a second body including the power conversion unit, the communication unit, the control unit, the power supply unit, and the like for controlling the operation of the multiple transmitting coils 320.

And, the body of the charger 300 may be provided with an output unit such as a display or a speaker, a user input unit, a socket for supplying power, or an interface for coupling external equipment. The display may be formed on the upper surface of the front case 311, and the user input unit, the socket, or the like may be disposed on the side surface of the body.

Accordingly, a power transmitting apparatus can wirelessly transmit power to a wireless power receiving device without a large change in its charging efficiency regardless of the position of the wireless power receiving device in the charging region of the power transmitting apparatus.

Throughout the description, it should be understood by those skilled in the art that various changes and modifications are possible without departing from the technical principles of the present invention. Therefore, the technical scope of the present invention is not limited to the detailed descriptions in this specification but should be defined by the scope of the appended claims.

What is claimed is:

1. Multiple coils for wireless power transmission, comprising:
a first transmitting coil stacked in a multilayer structure; and
a second transmitting coil stacked in the multilayer structure,
wherein outer edge of the first transmitting coil and outer edge of the second transmitting coil overlap each other, and layers of the first transmitting coil and the second transmitting coil are stacked in turn.

2. The multiple coils for wireless power transmission of claim 1, wherein each layer of the first and second transmitting coils is manufactured by a multilayer PCB manufacturing process to form a wire of a spiral shape.

3. The multiple coils for wireless power transmission of claim 2, wherein the each layer of the first and second transmitting coils is formed through processes including circuit printing, etching and resist stripping in the multilayer PCB manufacturing process.

4. The multiple coils for wireless power transmission of claim 2, wherein the each layer of the first and second transmitting coils is connected to a previous layer and a next layer through vias formed at an inner terminal and an outer terminal of the wire of the spiral shape.

5. The multiple coils for wireless power transmission of claim 4, wherein the inner terminal of the spiral-shaped wire is connected to the previous layer and the outer terminal of the spiral-shaped wire is connected to the next layer in an even-numbered layer of the first and second transmitting coils, and the inner terminal of the spiral-shaped wire is connected to the next layer and the outer terminal of the spiral-shaped wire is connected to the previous layer in an odd-numbered layer of the first and second transmitting coils, or
wherein the outer terminal of the spiral-shaped wire is connected to the previous layer and the inner terminal of the spiral-shaped wire is connected to the next layer in an even-numbered layer of the first and second transmitting coils, and the outer terminal of the spiral-shaped wire is connected to the next layer and the inner terminal of the spiral-shaped wire is connected to the previous layer in an odd-numbered layer of the first and second transmitting coils.

6. The multiple coils for wireless power transmission of claim 1, wherein each layer of the first and second transmitting coils is manufactured by a multilayer PCB manufacturing process to form a wire of a single closed curve a part of which is cut off to have two terminals, and
wherein a first terminal of the two terminals is connected to a previous layer through a first via and the a second terminal of the two terminals is connected to a next layer through a second via.

7. The multiple coils for wireless power transmission of claim 6, wherein positions of the two terminals in respective layers move by a distance between the two terminals in a same direction along the single closed curve as layers advance, or
wherein the positions of the two terminals are same in the respective layers, and directions in which the cut-offed part in the single closed curve is connected to the two terminals are alternatively changed depending on whether a corresponding layer is an odd-numbered layer or an even-numbered layer.

8. A wireless power transmitting apparatus, comprising:
multiple transmitting coils for changing a magnetic field by an alternating current, including a first coil stacked in a multilayer structure and a second coil stacked in the multilayer structure, outer edge of the first transmitting coil and outer edge of the second transmitting coil overlapping each other;
a shielding part for limiting propagation of the magnetic field generated in the multiple transmitting coils; and
a case for surrounding the multiple transmitting coils and the shielding part,
wherein layers of the first coil and the second coil are stacked in turn.
